(19) United States
(12) Patent Application Publication
(10) Pub. No.: US 2018/0031846 A1
(43) Pub. Date: Feb. 1, 2018

(54) SMART GLASSES AND METHOD FOR CONTROLLING THE SAME

(71) Applicants: HONGFUJIN PRECISION ELECTRONICS (ZHENGZHOU) CO., LTD., Zhengzhou (CN); HON HAI PRECISION INDUSTRY CO., LTD., New Taipei (TW)

(72) Inventor: Qi-Luo ZHANG, Zhengzhou (CN)

(21) Appl. No.: 15/657,229

(22) Filed: Jul. 24, 2017

(30) Foreign Application Priority Data
Jul. 29, 2016 (CN) 201610625319.2

(51) Int. Cl. G02B 27/01; G01B 7/02; H01H 19/10

(52) U.S. Cl. CPC G02B 27/0176; H01H 19/10; G01B 7/023; G02B 2027/0178

(57) ABSTRACT

Smart glasses which is automatically activated by being used includes a display screen, a frame and two legs. A switch is located on a joint between the frame and one of the two legs. The switch turns on when the two legs rotate away and the switch turns off when the two legs rotate together. A state of the switch is acquired when the smart glasses is in a sleep mode and the display screen is activated when the switch turns on, and sensors on the smart glasses can further sense and detect physical characteristics of a user to identify the user and his authority and thus prevent or allow the automatic activation.

### CROSS-REFERENCE TO RELATED APPLICATIONS

This application claims priority to Chinese Patent Application No. 201610625319.2 filed on Jul. 29, 2016, the contents of which are incorporated by reference herein.

### FIELD

The subject matter herein generally relates to control technology, and particularly to a smart glasses and a method for controlling the smart glasses.

### BACKGROUND

Activating smart glasses from a sleep mode by pressing a physical button of the smart glasses is not always easy for a user.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic diagram of one exemplary embodiment of smart glasses.

FIG. 2 is a block diagram of one exemplary embodiment of the smart glasses including a controlling system.

FIG. 3 illustrates a flow chart of a first exemplary embodiment of a method for controlling the smart glasses of FIG. 1.

FIG. 4 illustrates a flow chart of a second exemplary embodiment of a method for controlling the smart glasses of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, referencing the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as JAVA, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

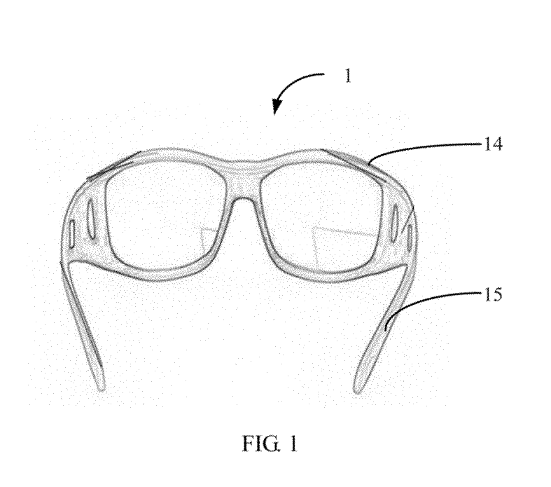

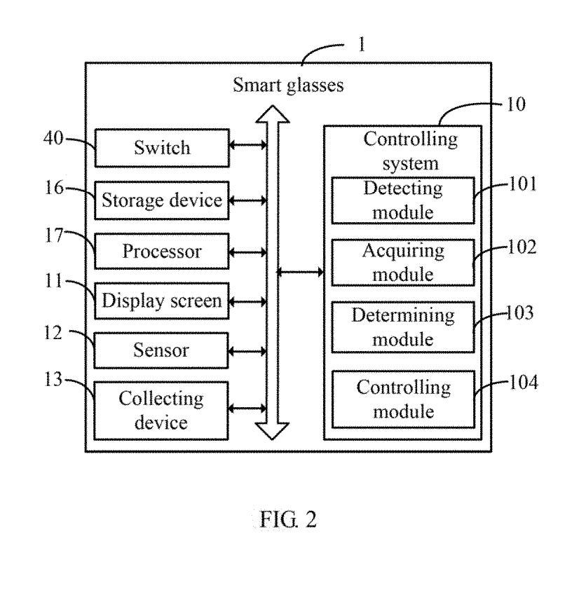

FIG. 2 is a block diagram of one embodiment of smart glasses 1 including a controlling system. Depending on the embodiment, the smart glasses 1 can include, but is not limited to, a controlling system 10, a display screen 11, at least one sensor 12, at least one collecting device 13, a frame 14, two legs 15 (shown in FIG. 1), a storage device 16, and at least one processor 17. FIG. 2 illustrates only one example of the smart glasses 1, other examples can include more or fewer components than as illustrated, or have a different configuration of the various components in other exemplary embodiments.

In at least one exemplary embodiment, the display screen 11 can display a user interface of the smart glasses 1. The at least one sensor 12 can detect environmental data around the smart glasses 1. The at least one collecting device 13 can collect data as to physical characteristics of a user.

In at least one exemplary embodiment, the frame 14 is connected to the two legs 15, and the two legs 15 can rotate relatively to the frame 14, as shown in FIG. 1. The two legs 15 can rotate toward or away from the frame 14. When a user needs to wear the smart glasses 1, the two legs 15 can rotate to away from the frame 14. When the user does not need to wear the smart glasses 1, the two legs 15 can rotate toward the frame 14.

There is a switch 40 located on a joint between the frame 14 and one of the two legs 15. A state of the switch 40 depends on the relative positions of the frame 14 and the two legs 15. For example, the switch 40 turns on when the two legs 15 rotate away from the frame 14, and the switch 40 turns off when the two legs 15 rotate toward the frame 14. In at least one exemplary embodiment, the switch 40 can be a mechanical switch, an electronic switch, or a physical switch (e.g., Hall switch).

In at least one exemplary embodiment, the storage device 16 can be a memory of the smart glasses 1. In other exemplary embodiments, the storage device 16 can be a secure digital card, or other external storage device such as a smart media card. In at least one exemplary embodiment, the controlling system 10 can store physical characteristics data of at least one authorized user into the storage device 16. The physical characteristics data can include voice data and fingerprint data of the at least one authorized user.

The at least one processor 17 can be a central processing unit (CPU), a microprocessor, or other data processor chip that performs functions of the smart glasses 1. In at least one exemplary embodiment, the at least one processor 17 is electrically connected to the switch 40, the at least one sensor 12, and the at least one collecting device 13.

In at least one exemplary embodiment, the controlling system 10 can include a detecting module 101, an acquiring module 102, a determining module 103, and a controlling module 104. The modules 101-104 include computerized codes in the form of one or more programs that may be stored in the storage device 16. The computerized codes include instructions that can be executed by the at least one processor 17.

In at least one exemplary embodiment, when the smart glasses 1 is in sleep mode, the detecting module 101 can detect whether the switch 40 is on or off. When the switch 40 turns on, the two legs 15 are rotated to away from the frame 14 and the user is going to use the smart glasses 1. The controlling module 104 can control the smart glasses 1 to activate the display screen 11.

In at least one exemplary embodiment, the processer 17 is electronically connected to two ends of the switch 40. The switch 40 can send electronic signal to the processer 17 when the switch 40 turns on. The detecting module 101 can determine that the switch 40 turns on after receiving the electronic signal.

In at least one exemplary embodiment, the controlling module 104 can activate the at least one sensor 12 to detect the environmental data around the smart glasses 1 when the switch 40 turns on. The environmental data can include whether an object exists within a predetermined range from the smart glasses 1 or not and environment temperature around the smart glasses 1. The acquiring module 102 can acquire the detected environmental data from the at least one sensor 12. The determining module 103 can determine whether a user is going to use the smart glasses 1 according to the detected environmental data. The controlling module 104 can control the smart glasses 1 to activate the display screen 11 when the user is determined as using the smart glasses 1.

In at least one exemplary embodiment, the at least one sensor 12 can include a proximity sensor and a temperature sensor. The proximity sensor can detect whether an object exists within the predetermined range from the smart glasses 1. The temperature sensor can detect the environment temperature around the smart glasses 1. The determining module 103 can detect whether the user is going to use the smart glasses 1 according to the environmental data. In detail, when the object exists within the predetermined range from the smart glasses 1 and the environment temperature is within a range of human body temperatures, the determining module 103 can determine that the user is going to use the smart glasses 1. When no object exists within the predetermined range from the smart glasses 1 or the environment temperature is out of the range of human body temperatures, the determining module 103 can determine that the user is not using or is not going to use the smart glasses 1.

In at least one exemplary embodiment, the controlling module 104 can activate the at least one collecting device 13 to collect the physical characteristics data of a user when the switch 40 turns on. The physical characteristics data can include voice data and fingerprint data of the user. The acquiring module 102 can acquire the physical characteristics data from the at least one collecting device 13. The determining module 103 can determine the identity of the user, thus whether the user has authority to use the smart glasses 1 according to the acquired physical characteristics data. The controlling module 104 can control the smart glasses 1 to activate the display screen 11 when the user has authority to use the smart glasses 1.

In at least one exemplary embodiment, the at least one collecting device 13 can include a microphone and a fingerprint collector. The microphone can collect voice data of the user. The fingerprint collector can collect fingerprint data of the user. The controlling module 104 can prompt the user to input voice and/or fingerprint to verify whether the user has authority to use the smart glasses 1 when the switch 40 turns on. The determining module 103 can compare the inputted voice data with the stored voice data to determine the identity of the user, thus whether the user has authority to use the smart glasses 1. When the inputted voice data is the same as the stored voice data, the determining module 103 determined that the user has authority to use the smart glasses 1 and the controlling module 104 can activate the display screen 11 of the smart glasses 1. When the inputted voice data is different from the stored voice data, the determining module 103 can determine that the user is unknown and thus does not have authority to use the smart glasses 1. The controlling module 104 thus will not activate the display screen 11 of the smart glasses 1.

In at least one exemplary embodiment, the determining module 103 also can compare the inputted fingerprint data with the stored fingerprint data to determine whether the user has authority to use the smart glasses 1. When the inputted fingerprint data is the same as the stored fingerprint data, the determining module 103 can determine that the user is identified, and that the user has authority to use the smart glasses 1. The controlling module 104 can activate the display screen 11 of the smart glasses 1. When the inputted fingerprint data is different from the stored fingerprint data, the determining module 103 determined that the user is unknown and thus does not have authority to use the smart glasses 1. The controlling module 104 thus will not activate the display screen 11 of the smart glasses 1.

In at least one exemplary embodiment, at least one collecting device 13 further can include a gravity sensor and an angle sensor. The determining module 103 can detect whether the smart glasses 1 is stationary or otherwise according to data which acquired from the gravity sensor and the angle sensor. When the determining module 103 detects that the smart glasses 1 is in motion, it is determined that the user is going to use the smart glasses 1. Then, the controlling module 104 can control the smart glasses 1 to activate the display screen 11.

In other exemplary embodiment, there is no switch 40 on the smart glasses 1, and the determining module 103 can determine whether the smart glasses 1 is used by the user according to data collected from the at least one collecting device 13. The controlling module 104 can control the smart glasses 1 to activate the display screen 11 when the user uses the smart glasses 1.

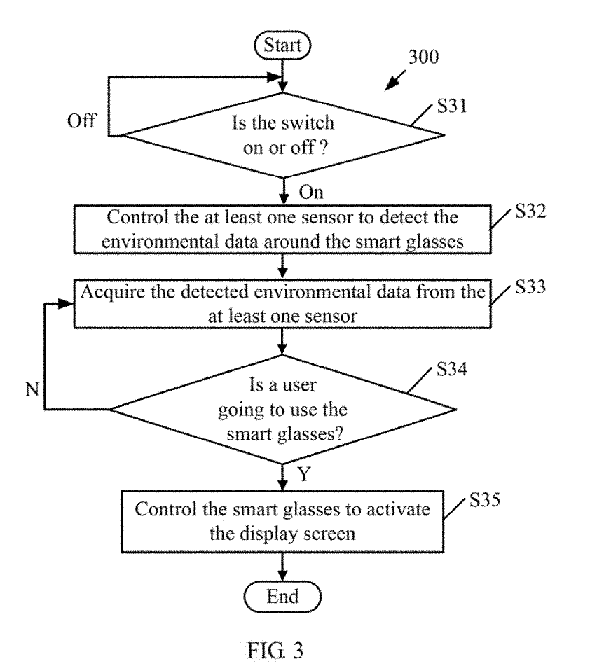

FIG. 3 illustrates a flowchart which is presented in accordance with an example embodiment. The exemplary method 300 is provided by way of example, as there are a variety of ways to carry out the method. The method 300 described below can be carried out using the configurations illustrated in FIG. 1, for example, and various elements of these figures are referenced in explaining exemplary method 300. Each block shown in FIG. 3 represents one or more processes, methods, or subroutines, carried out in the exemplary method 300. Additionally, the illustrated order of blocks is by example only and the order of the blocks can be changed according to the present disclosure. The exemplary method 300 can begin at block S31. Depending on the embodiment, additional steps can be added, others removed, and the ordering of the steps can be changed.

At block S31, the detecting module 101 can detect whether the switch 40 is on or off when the smart glasses 1 is in sleep mode. When the switch 40 turns on, the process goes to block S32. When the switch 40 turns off, the process goes back to block S31 until the switch 40 turns on. In this exemplary embodiment, the process S32 to the process S34 can remove.

At block S32, the controlling module 104 can control the at least one sensor 12 to detect the environmental data around the smart glasses 1 when the switch 40 turns on.

In at least one exemplary embodiment, the environmental data can include whether an object exists within a predetermined range from the smart glasses 1 or not and environment temperature around the smart glasses 1. The at least one sensor 12 can include a proximity sensor and a temperature sensor. The proximity sensor can detect whether an object exists within the predetermined range from the smart glasses 1. The temperature sensor can detect the environment temperature around the smart glasses 1.

At block S33, the acquiring module 102 can acquire the detected environmental data from the at least one sensor 12.

At block S34, the determining module 103 can determine the user is going to use the smart glasses 1 according to the detected environmental data. When the user is going to use the smart glasses 1, the process goes to block S35. When the user is not using or is not going to use the smart glasses 1, the process goes back to block S33.When the proximity sensor detected that the object exists within the predetermined range from the smart glasses 1 and the environment temperature detected by the temperature sensor is within a range of human body temperatures, the determining module 103 determined that the user is going to use the smart glasses 1. When the proximity sensor detected that no object exists within the predetermined range from the smart glasses 1 and the environment temperature detected by the temperature sensor is out of the range of human body temperatures, the determining module 103 determined that the user is not using or is not going to use the smart glasses 1.

At block S35, the controlling module 104 can control the smart glasses 1 to activate the display screen 11.

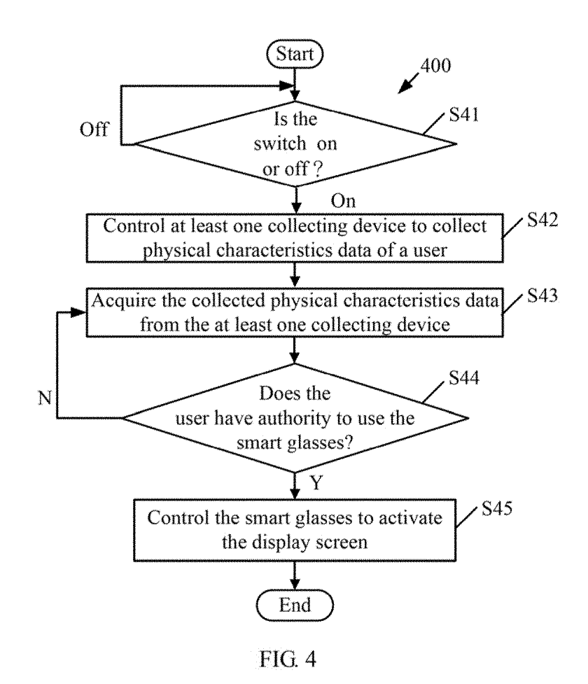

FIG. 4 illustrates a flowchart which is presented in accordance with an example embodiment. The exemplary method 400 is provided by way of example, as there are a variety of ways to carry out the method. The method 400 described below can be carried out using the configurations illustrated in FIG. 1, for example, and various elements of these figures are referenced in explaining exemplary method 400. Each block shown in FIG. 4 represents one or more processes, methods, or subroutines, carried out in the exemplary method 400. Additionally, the illustrated order of blocks is by example only and the order of the blocks can be changed according to the present disclosure. The exemplary method 400 can begin at block S41. Depending on the embodiment, additional steps can be added, others removed, and the ordering of the steps can be changed.

At block S41, the detecting module 101 can detect whether the switch 40 turns on or off when the smart glasses 1 is in sleep mode. When the switch 40 turns on, the process goes to block S42. When the switch 40 turns off, the process goes back to block S41 until the switch 40 turns on.

At block S42, the controlling module 104 can control the at least one collecting device 13 to collect the physical characteristics data of a user when the switch 40 turns on.

In at least one exemplary embodiment, the physical characteristics data can include voice data and fingerprint data of the user. The at least one collecting device 13 can include a microphone and a fingerprint collector. The microphone can collect voice data of the user. The fingerprint collector can collect fingerprint data of the user.

At block S43, the acquiring module 102 can acquire the collected physical characteristics data from the at least one collecting device 13.

At block S44, the determining module 103 can determine whether the user has authority to use the smart glasses 1. When the user has authority to use the smart glasses 1, the process goes to block S45. When the user does not have authority to use the smart glasses 1, the process goes back to block S43.

The controlling module 104 can prompt the user to input voice and/or fingerprint to verify whether the user has authority to use the smart glasses 1 when the switch 40 turns on. The determining module 103 can compare the inputted voice data with the stored voice data to determine whether the user has authority to use the smart glasses 1. When the inputted voice data is the same as the stored voice data, the determining module 103 determined that the user has authority to use the smart glasses 1. When the inputted voice data is different from the stored voice data, the determining module 103 determined that the user does not have authority to use the smart glasses 1.

In at least one exemplary embodiment, the determining module 103 also can compare the inputted fingerprint data with the stored fingerprint data to determine whether the user has authority to use the smart glasses 1. When the inputted fingerprint data is the same as the stored fingerprint data, the determining module 103 determined that the user has authority to use the smart glasses 1. When the inputted fingerprint data is different from the stored fingerprint data, the determining module 103 determined that the user does not have authority to use the smart glasses 1.

At block S45, the controlling module 104 can control the smart glasses 1 to activate the display screen 11.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A pair of smart glasses comprising:
a display screen;
a frame and two legs, wherein the frame is connected to the two legs, and the two legs are rotatable relatively to the frame;
a switch located on a joint between the frame and one of the two legs, wherein the switch turns on when the two legs rotate to away from the frame, and the switch turns off when the two legs rotate toward the frame;
a storage device; and
at least one processor, wherein the at least one processor is electrically connected to the switch;
the storage device storing one or more programs, voice data and fingerprint data of at least one authorized user, which when executed by the at least one processor, cause the at least one processor to:
acquire a state of the switch when the smart glasses is in sleep mode; and
activate the display screen when the switch turns on.

2. The smart glasses according to claim 1, wherein the at least one processor is further caused to:
control at least one sensor to detect environmental data around the smart glasses when the switch turns on;
determine whether a user is going to use the smart glasses according to the detected environmental data; and
activate the display screen when the user is going to use the smart glasses.

3. The smart glasses according to claim 2, wherein the at least one sensor is located on the two legs and electrically connected to the at least one processor, and the at least one sensor comprises a proximity sensor and a temperature sensor.

4. The smart glasses according to claim 3, wherein the environmental data comprises:
whether an object exists within a predetermined range from the smart glasses which is detected by the proximity sensor; and
environment temperature which is detected by the temperature sensor.

5. The smart glasses according to claim 4, wherein when the object exists within the predetermined range from the smart glasses and the environment temperature is within a range of human body temperatures, the at least one processor determines that the user is going to use the smart glasses; and
when no object exists within the predetermined range from the smart glasses or the environment temperature is out of the range of human body temperatures, the at least one processor determines that the user is not going to use the smart glasses.

6. The smart glasses according to claim 1, wherein the at least one processor is further caused to:
control at least one collecting device to collect physical characteristics data of a user when the switch turns on;
determine whether the user has authority to use the smart glasses according to the collected physical characteristics data; and
activate the display screen when the user has authority to use the smart glasses.

7. The smart glasses according to claim 6, wherein the at least one collecting device is electrically connected to the at least one processor and the at least one collecting device comprises a microphone and a fingerprint collector.

8. The smart glasses according to claim 7, wherein the physical characteristics data comprising:
voice data of the user which is collected by the microphone; and
fingerprint data of the user which is collected by the fingerprint collector.

9. The smart glasses according to claim 8, wherein when the voice data is the same as the stored voice data of the at least one authorized user or the fingerprint data is the same as the stored fingerprint data of the at least one authorized user, the at least one processor determines that the user has authority to use the smart glasses; and
when the voice data is different from the stored voice data of the at least one authorized user and the fingerprint data is different from the stored fingerprint data of the at least one authorized user, the at least one processor determines that the user does not have authority to use the smart glasses.

10. A method for controlling a pair of smart glasses, the smart glasses comprising:
a display screen;
a frame and two legs, wherein the frame is connected to the two legs, and the two legs are rotatable relatively to the frame;
a switch located on a joint between the frame and one of the two legs, wherein the switch turns on when the two legs rotate to away from the frame, and the switch turns off when the two legs rotate toward the frame; and
a storage device that stores voice data and fingerprint data of at least one authorized user, the method comprising:
acquiring a state of the switch when the smart glasses is in sleep mode; and
activating the display screen when the switch turns on.

11. The method according to claim 10, further comprising:
controlling at least one sensor to detect environmental data around the smart glasses when the switch turns on;
determining whether a user is going to use the smart glasses according to the detected environmental data; and
activating the display screen when the user is going to use the smart glasses.

12. The method according to claim 11, wherein the at least one sensor is located on the two legs and electrically connected to at least one processor of the smart glasses, and the at least one sensor comprises a proximity sensor and a temperature sensor.

13. The method according to claim 12, wherein the environmental data comprises:
whether an object exists within a predetermined range from the smart glasses which is detected by the proximity sensor; and
environment temperature which is detected by the temperature sensor.

14. The method according to claim 13, wherein when the object exists within the predetermined range from the smart glasses and the environment temperature is within a range of human body temperatures, the at least one processor determines that the user is going to use the smart glasses; and
when no object exists within the predetermined range from the smart glasses or the environment temperature is out of the range of human body temperatures, the at least one processor determines that the user is not going to use the smart glasses.

15. The method according to claim 10, further comprising:
controlling at least one collecting device to collect physical characteristics data of a user when the switch turns on;
determining whether the user has authority to use the smart glasses according to the collected physical characteristics data; and
activating the display screen when the user has authority to use the smart glasses.

16. The method according to claim 15, wherein the at least one collecting device is electrically connected to at least one processor of the smart glasses and the at least one collecting device comprises a microphone and a fingerprint collector.

17. The method according to claim 16, wherein the physical characteristics data comprises:
voice data of the user which is collected by the microphone; and
fingerprint data of the user which is collected by the fingerprint collector.

18. The method according to claim 17, wherein when the voice data is the same as the stored voice data of the at least one authorized user or the fingerprint data is the same as the stored fingerprint data of the at least one authorized user, the at least one processor determines that the user has authority to use the smart glasses; and
when the voice data is different from the stored voice data of the at least one authorized user and the fingerprint data is different from the stored fingerprint data of the at least one authorized user, the at least one processor determines that the user does not have authority to use the smart glasses.

19. A non-transitory storage medium having stored thereon instructions that, when executed by a processor of a pair of smart glasses, causes the processor to perform a controlling method, the smart glasses comprising:
a display screen;
a frame and two legs, wherein the frame is connected to the two legs, and the two legs are rotatable relatively to the frame;
a switch located on a joint between the frame and one of the two legs, wherein the switch turns on when the two legs rotate to away from the frame, and the switch turns off when the two legs rotate toward the frame; and
a storage device that stores voice data and fingerprint data of at least one authorized user, wherein the method comprises:
acquiring a state of the switch when the smart glasses is in sleep mode; and
activating the display screen when the switch turns on.

20. The non-transitory storage medium according to claim 19, further comprising:
controlling at least one sensor to detect environmental data around the smart glasses when the switch turns on;
determining whether a user is going to use the smart glasses according to the detected environmental data; and
activating the display screen when the user is going to use the smart glasses.

21. The non-transitory storage medium according to claim 20, wherein the at least one sensor is located on the two legs and electrically connected to at least one processor of the smart glasses, and the at least one sensor comprises a proximity sensor and a temperature sensor.

22. The non-transitory storage medium according to claim 21, wherein the environmental data comprises:
whether an object exists within a predetermined range from the smart glasses which is detected by the proximity sensor; and
environment temperature which is detected by the temperature sensor.

23. The non-transitory storage medium according to claim 22, wherein when the object exists within the predetermined range from the smart glasses and the environment temperature is within a range of human body temperatures, the at least one processor determines that the user is going to use the smart glasses; and
when no object exists within the predetermined range from the smart glasses or the environment temperature is out of the range of human body temperatures, the at least one processor determines that the user is not going to use the smart glasses.

24. The non-transitory storage medium according to claim 19, further comprising:
controlling at least one collecting device to collect physical characteristics data of a user when the switch turns on;
determining whether the user has authority to use the smart glasses according to the collected physical characteristics data; and
activating the display screen when the user has authority to use the smart glasses.

25. The non-transitory storage medium according to claim 24, wherein the at least one collecting device is electrically connected to at least one processor of the smart glasses and the at least one collecting device comprises a microphone and a fingerprint collector.

26. The non-transitory storage medium according to claim 25, wherein the physical characteristics data comprises:
voice data of the user which is collected by the microphone; and
fingerprint data of the user which is collected by the fingerprint collector.

27. The non-transitory storage medium according to claim 26, wherein when the voice data is the same as the stored voice data of the at least one authorized user or the fingerprint data is the same as the stored fingerprint data of the at least one authorized user, the at least one processor determines that the user has authority to use the smart glasses; and
when the voice data is different from the stored voice data of the at least one authorized user and the fingerprint data is different from the stored fingerprint data of the at least one authorized user, the at least one processor determines that the user does not have authority to use the smart glasses.
